(19) United States
(12) Patent Application Publication
(10) Pub. No.: US 2025/0266017 A1
(43) Pub. Date: Aug. 21, 2025

(54) Thumb-side, supernumerarily-widened neck for a non-drone string, handheld stringed musical instrument with a single neck

(71) Applicant: Thomas John Kelly, Cocoa, FL (US)

(72) Inventor: Thomas John Kelly, Cocoa, FL (US)

(21) Appl. No.: 18/444,605

(22) Filed: Feb. 16, 2024

(51) Int. Cl. G10D 3/06

(52) U.S. Cl. CPC G10D 3/06

(57) ABSTRACT

Neck construction for a ‘non-drone string, handheld stringed musical instrument with a single neck’, such as a classical guitar or a violin, that provides for a thumb-side, supernumerarily-widened neck as defined by at least ⅜ of an inch of neck width blended into the neck profile with such blending and requisite shape altering occurring between the thumb-side longitudinal edge of the neck and a perpendicular projection of the last string in the string set and with such blending and requisite shape altering being coordinated and occurring in tandem, if necessary, across all other regions of the entire neck. Such a thumb-side, supernumerarily-widened neck design provides the musician, given a suitably large hand, with more ergonomic mechanical leverage and therefore more string control when conventionally bending the strings or performing a lateral vibrato and, perhaps to a lesser extent, more ergonomic mechanical leverage when conventionally fretting, stopping or barring the strings because in both cases the hand and particularly the thumb will be more ergonomically open.

### CROSS-REFERENCE TO RELATED APPLICATIONS

Not Applicable.

### THE NAMES OF THE PARTIES TO A JOINT RESEARCH AGREEMENT

Not Applicable.

### BACKGROUND OF THE INVENTION

Terminology For This Application:

Each of the following terms shall appear in this application within single quotes and are defined as follows—

‘Non-drone string, handheld stringed musical instrument with a single neck’—a handheld stringed musical instrument comprising a single neck where each and every string, when openly plucked, oscillates from its assigned top edge of the nut to its assigned top edge of the bridge or saddle, and where by design the functional direction of the nut slot is perpendicular to the neck's longitudinal, vertically-cut bisecting plane and where by design, for a scalloped neck adopt the exact same scalloped neck design but envisioned without the neck blank or glued-on fretboard being physically scalloped, the two longitudinal edges of the neck surface area, such neck surface area being continuous and lying immediately underneath the suspended, longitudinal run of the strings and envisioned without, if present, any frets, then extending to both longitudinal edges where these two contiguous longitudinal halves of the neck surface area terminate and such neck surface area being where by design the musician frets, stops or barres the strings (this continuous neck surface area is formally defined below as the ‘neck face’ but within the non-circular context of ‘non-drone string, handheld stringed musical instrument with a single neck’ and ‘below the nut slot’), are both straight line segments whose respective starting points are at the infinitesimally shortest distance away from the nut slot with each line segment then linearly following its longitudinal edge until it terminates at the extreme opposite end of the said neck surface area. For this application a ‘non-drone string, handheld stringed musical instrument with a single neck’ is restricted to the following instrument types—6-string electric guitars, 6-string, steel string acoustic guitars, classical guitars, 4-string electric basses, ukuleles, mandolins, violins and violas and their multi-string, but not multi-neck, variants. Finally as a contrasting example, a 5-string banjo is a “drone string, handheld stringed musical instrument with a single neck” instrument type because it has a drone string whose upper oscillation anchor point starts, not at an assigned top edge of the nut, but at the fifth fret and therefore when openly plucked oscillates from, not the nut, but, the fifth fret to its corresponding top edge of the bridge.

‘Non-drone string, handheld stringed musical instrument with a thumb-side, supernumerarily-widened neck’—any ‘non-drone string, handheld stringed musical instrument with a single neck’ that has a thumb-side, supernumerarily-widened neck as described and claimed by this application.

‘Homogeneous fingerboard/fretboard extension’—on any ‘non-drone string, handheld stringed musical instrument with a single neck’ or stand-alone neck for such an instrument, the portion of the fingerboard or fretboard that may extend beyond the heel and is not a part of a glued-on fingerboard or fretboard, but rather is shaped along with the rest of the neck from a single neck blank.

‘Below the nut slot’—on any ‘non-drone string, handheld stringed musical instrument with a single neck’ or stand-alone neck for such an instrument, all portions of the neck that are entirely on the same side of the nut slot as the heel.

‘Above or at the nut slot’—on any ‘non-drone string, handheld stringed musical instrument with a single neck’ or stand-alone neck for such an instrument, all portions of the neck that are not ‘below the nut slot’.

‘Neck face’—on any ‘non-drone string, handheld stringed musical instrument with a single neck’ or stand-alone neck for such an instrument, the continuous neck surface area, which is often a glued-on fingerboard's or fretboard's surface area, that is ‘below the nut slot’ and that lies immediately underneath the suspended, longitudinal run of the strings or immediately underneath where the suspended, longitudinal run of the strings is designed to be, then extends to all neck surface area edges ‘below the nut slot’ and where at such edges the neck surface area then terminates. The ‘neck face’ is where by design the musician frets, stops or barres the strings, however, any frets, if present, are not considered to be a part of the ‘neck face’.

‘Finger-side longitudinal edge of the ‘neck face”—on any ‘non-drone string, handheld stringed musical instrument with a single neck’ or stand-alone neck for such an instrument, the entire longitudinal edge of the ‘neck face’ where the musician wraps his or her fingers over that longitudinal edge when conventionally fretting, stopping or barring the strings.

‘Thumb-side longitudinal edge of the ‘neck face”—on any ‘non-drone string, handheld stringed musical instrument with a single neck’ or stand-alone neck for such an instrument, the entirety of the longitudinal edge of the ‘neck face’ that is not the ‘finger-side longitudinal edge of the ‘neck face” keeping in mind that the ‘neck face’ on any such instrument or stand-alone neck has two and only two longitudinal edges. The musician often anchors his or her thumb along this longitudinal edge of the ‘neck face’, even on a scalloped neck, and hence “thumb-side” appears in this term's name.

‘Neck width plane’—on any ‘non-drone string, handheld stringed musical instrument with a single neck’ or stand-alone neck for such an instrument, the plane that inclusively lies between all points along the ‘thumb-side longitudinal edge of the ‘neck face” and all points along the ‘finger-side longitudinal edge of the ‘neck face” then continuously extends in all directions. Note: The ‘neck face’ is not always a flat surface but rather is often convex, i.e. radiused, and may even be concave, i.e. scalloped, between the frets although the frets are never considered to be a part of the ‘neck face’.

‘Neck width at the nut slot’—on any ‘non-drone string, handheld stringed musical instrument with a single neck’ or stand-alone neck for such an instrument, the length of the line segment that lies on the ‘neck width plane’ and terminates at one end at the ‘thumb-side longitudinal edge of the ‘neck face” and terminates at the other end at the ‘finger-side longitudinal edge of the ‘neck face” and where the line segment's continuous line is parallel to the functional direction of the nut slot and is at the infinitesimally shortest parallel distance away from the nut slot.

‘Finger-side string set indentation at the nut slot’—on any ‘non-drone string, handheld stringed musical instrument with a single neck’ or stand-alone neck for such an instrument, the indentation line segment that lies on the same line as the ‘neck width at the nut slot”s line segment with one indentation endpoint at the intersection of, for an instrument, the perpendicular projection, perpendicular in relation to the ‘neck width plane’, but for a stand-alone neck the anticipated perpendicular projection of the first string in the string set onto this line and with the other indentation endpoint at the intersection of this same line and the ‘finger-side longitudinal edge of the ‘neck face”.

‘Thumb-side string set indentation at the nut slot’—on any ‘non-drone string, handheld stringed musical instrument with a single neck’ or stand-alone neck for such an instrument, the indentation line segment that lies on the same line as the ‘neck width at the nut slot”s line segment with one indentation endpoint at the intersection of, for an instrument, the perpendicular projection, perpendicular in relation to the ‘neck width plane’, but for a stand-alone neck the anticipated perpendicular projection of the last string in the string set onto this line and with the other indentation endpoint at the intersection of this same line and the ‘thumb-side longitudinal edge of the ‘neck face”.

‘Finger-side continuous set of indentations’—on any ‘non-drone string, handheld stringed musical instrument with a single neck’ or stand-alone neck for such an instrument, the set of indentation line segments that originate from every point along the ‘finger-side longitudinal edge of the ‘neck face” where each such point is an endpoint for the indentation line segment that is parallel to the ‘neck width at the nut slot”s line segment and has as its other endpoint the intersection of, for an instrument, the perpendicular projection, perpendicular in relation to the ‘neck width plane’, but for a stand-alone neck the anticipated perpendicular projection of the first string in the string set onto this indentation line segment's line.

‘Thumb-side continuous set of indentations’—on any ‘non-drone string, handheld stringed musical instrument with a single neck’ or stand-alone neck for such an instrument, the set of indentation line segments that originate from every point along the ‘thumb-side longitudinal edge of the ‘neck face” where each such point is an endpoint for the indentation line segment that is parallel to the ‘neck width at the nut slot”s line segment and has as its other endpoint the intersection of, for an instrument, the perpendicular projection, perpendicular in relation to the ‘neck width plane’, but for a stand-alone neck the anticipated perpendicular projection of the last string in the string set onto this indentation line segment's line.

‘Overall neck length’—on any ‘non-drone string, handheld stringed musical instrument with a single neck’ or stand-alone neck for such an instrument, the longitudinal length of the neck as measured from one extreme longitudinal end of the neck such longitudinal end being either the heel or the ‘homogeneous fingerboard/fretboard extension’ to the opposite extreme longitudinal end of the neck such longitudinal end often called the headstock, scroll or peghead. The ‘overall neck length’ does not consider, if present, a glued-on fingerboard or fretboard, but rather only portions of the neck that have been constructed entirely from the neck's neck blank.

Maximum neck width from the last string to the ‘finger-side longitudinal edge of the ‘neck face”—after evaluating all points along the ‘finger-side longitudinal edge of the ‘neck face” on any ‘non-drone string, handheld stringed musical instrument with a single neck’ or stand-alone neck for such an instrument, the length of the line segment that has the maximum length when measured from the ‘finger-side longitudinal edge of the ‘neck face” to, for an instrument, the perpendicular projection but for a stand-alone neck the anticipated perpendicular projection of the last string in the string set onto the ‘neck width plane’, and where the line segment is parallel to the ‘neck width at the nut slot”s line segment.

‘Neck thickness at the nut slot’—on any ‘non-drone string, handheld stringed musical instrument with a single neck’ or stand-alone neck for such an instrument, the length of the line segment on a line that is perpendicular to the ‘neck width plane’ and runs through the ‘neck width at the nut slot”s line segment and has as one endpoint, its top endpoint, a point on the ‘neck face’ that is at the maximum perpendicular distance away from the ‘neck width plane’ and has as the other endpoint, its bottom endpoint, the intersection of this line segment's line with the plane that is parallel to the ‘neck width plane’ and is at the maximum perpendicular distance away from the ‘neck width plane’ while still touching any part of the neck that is perpendicularly, in relation to the ‘neck width plane’, beneath the ‘neck width at the nut slot”s line segment and therefore on the opposite side of the ‘neck width plane’ from where the strings are or from where the strings are designed to be.

‘Maximum neck thickness’—after evaluating all lines that are perpendicular to the ‘neck width plane’ and which also run through any portion of the neck on any ‘non-drone string, handheld stringed musical instrument with a single neck’ or stand-alone neck for such an instrument, the length of the line segment on any such line that has for one endpoint, its top endpoint, a point on the top surface of the neck that is at the maximum perpendicular distance away from the ‘neck width plane’ and has as the other endpoint, its bottom endpoint, the intersection of this line segment's line with the plane that is parallel to the ‘neck width plane’ and is at the maximum perpendicular distance away from the ‘neck width plane’ while still touching any part of the neck that is on the opposite side of the ‘neck width plane’ from where the strings are or from where the strings are designed to be.

‘Industry typical’—the collective union, grouped by instrument type, of every ‘non-drone string, handheld stringed musical instrument with a single neck’ including every stand-alone neck for such an instrument whose individual instruments or stand-alone necks have at the time of this application's submission each been already constructed within the last seventy years by one of that instrument's or stand-alone neck's twelve highest unit-volume domestic brands or five highest unit-volume non-domestic brands whose rankings were taken at the time of each individual instrument's or stand-alone neck's construction, and to note that consequently the ‘industry typical’ ‘finger-side string set indentation at the nut slot’ range, the ‘industry typical’ ‘thumb-side string set indentation at the nut slot’ range, the ‘industry typical’ ‘finger-side continuous set of indentations’ range, the ‘industry typical’ ‘thumb-side continuous set of indentations’ range, the ‘industry typical’ ‘maximum neck width from the last string to the ‘finger-side longitudinal edge of the ‘neck face” range and the ‘industry typical’ ‘neck width at the nut slot’ range for each ‘non-drone string, handheld stringed musical instrument with a single neck’ instrument type are defined by the corresponding minimum and maximum values contained within each instrument type's respective collective union.

‘Industry typical’ ‘string set configuration and placement’—dating continuously back to the days of guitar manufacturer Antonio de Torres' time, (1817-1892), then extending even further to the time of violin manufacturer Antonio Stradivari, (1644-1737) and beyond, thus including the ‘industry typical”s seventy-year time period, the standard practice has been for ‘non-drone string, handheld stringed musical instrument with a single neck’ manufacturers to, if not installing a suitable pre-manufactured nut, shape then install the nut as flush as possible with the nut slot, then measure off a ‘thumb-side string set indentation at the nut slot’ of less than ⅜ of an inch in length, typically either ⅛ of an inch or 3 mm, for the last string in the string set, typically the lowest pitched string, and a ‘finger-side string set indentation at the nut slot’ of less than ⅜ of an inch in length, typically either ⅛ of an inch or 3 mm, for the first string in the string set, typically the highest pitched string, such indentations marking by indication where the nut is to be slotted for the last string's and first string's respective placements such that each of these two strings can then be longitudinally suspended over the ‘neck face’ from its respective slotted top edge of the nut to its corresponding top edge of the bridge or saddle with the remaining nut width either partitioned into proportional spacings between all adjacent strings based upon each adjacent string's thickness or partitioned into equidistant spacings between all adjacent strings as measured from adjacent string edge-to-string edge or from each adjacent string's respective string center, thus marking by indication where the nut is to be slotted for each intermediary string so that each such string can then be longitudinally suspended over the ‘neck face’ from its respective slotted top edge of the nut to its corresponding top edge of the bridge or saddle.

‘Industry typical’ ‘string set configuration’—the elements of the ‘industry typical’ ‘string set configuration and placement’ pertaining only to the positional interrelationships amongst the strings in the set.

‘Industry typical’ ‘string set placement’—the elements of the ‘industry typical’ ‘string set configuration and placement’ pertaining only to its string set placement relative to the ‘finger-side longitudinal edge of the ‘neck face” and the ‘thumb-side longitudinal edge of the ‘neck face”.

All of the guitar brands referenced in this application are manufactured by high unit-volume, innovative and therefore industry leading corporations who may carry more than one guitar brand. Fortunately, as to avoid confusion, when a guitar manufacturing corporation does carry more than one brand, the brand referenced in this application always happens to be the brand synonymous, in common parlance terms, with its corporation name and therefore such brands will be referred to by this shared common parlance corporation/brand name in uppercase, otherwise, for the high unit-volume, industry leading guitar manufacturing corporations who carry only one brand, a brand name which likewise happens to fortuitously be in common parlance terms synonymous with its corporation's name, these brands will be referred to by its shared common parlance corporation/brand name in uppercase as well.

Furthermore regarding corporation names, the guitar manufacturing corporations whose guitar brands are referenced in this application may have changed their corporation name over the years of their evolving corporate existence and since this application references a few of these corporations across many decades, the Applicant is providing from Google searches what appears to be the present corporation name for each of these guitar manufacturers and lists them in double quotes along with their shared common parlance brand name in uppercase—
“C. F. Martin & Company” whose common parlance brand name in uppercase, MARTIN, will be used throughout this application to reference the corporation's self-identifying brand name;
“Fender Musical Instruments Corporation” whose common parlance brand name in uppercase, FENDER, will be used throughout this application to reference the corporation's self-identifying brand name;
“Gibson Brands, Inc.” whose common parlance brand name in uppercase, GIBSON, will be used throughout this application to reference the corporation's self-identifying brand name;

“Paul Reed Smith Guitars” whose common parlance brand name in uppercase, PAUL REED SMITH, will be used throughout this application to reference the corporation's self-identifying brand name;
“Taylor Guitars” whose common parlance brand name in uppercase, TAYLOR, will be used throughout this application to reference the corporation's self-identifying brand name.

Finally, geometric concepts such as point, line, plane, infinite, continuous, parallel, etc . . . and therefore geometric designs and descriptions in general are not attainable in the material world with absolute precision, yet their abstract properties and representations do nevertheless most accurately describe the many material objects and material objectives relied upon throughout musical instrument design and manufacture and therefore throughout this application such as in the above defined terms of ‘neck width plane’, ‘neck width at the nut slot’ and others.

### BACKGROUND OF THE INVENTION—SUMMARY

Antonio de Torres, 1817-1892, is considered by many to be the father of the modern classical guitar and today the classical guitar still has a ‘neck width at the nut slot’ of between 50 and 55 mm which is approximately between 1.9685 and 2.1654 inches, see Contemporary Acoustic Guitar Design and Build, 2nd Edition, 2016, ISBN: 978-0-9871174-2-7, Trevor Gore and Gerard Gilet, Volume 1: Design, Appendix VI-Dimensions (mm), Set-up and Performance Parameters of Guitars which also shows that for 6-string, steel string acoustic guitars the ‘neck width at the nut slot’ is between 43 and 47 mm which is approximately between 1.6929 and 1.8504 inches.

When steel strings began replacing animal gut strings in the 1920's more compression and tension was applied to the guitar's neck and soundboard, yet rather than making the neck wider or at least keeping it at the Torres standard, the high unit-volume guitar brands MARTIN and GIBSON began strengthening their next generation of acoustic guitars by inserting truss rods into the neck and devising new bracing patterns for the soundboard. Over the next few decades of such evolution the ‘neck width at the nut slot’ for a 6-string, steel string acoustic guitar would become narrower and narrower until finally becoming standardized by MARTIN and GIBSON to be within a sixteenth of an inch, specifically between 1.6875 and 1.7500 inches which is 1 11/16 and 1¾ inches respectively. This narrowing neck width trend would carry over to the 6-string electric guitars of the 1950's even though new styles of music such as rock-n-roll required a pronounced bending of the strings and the application of wide, lateral-the ultimate goal being a resonant signature-vibrato.

Conventional bending of the strings, especially steel strings, requires tremendous hand strength and even more so when simultaneously performing a lateral vibrato, thus a guitar or any other ‘non-drone string, handheld stringed musical instrument with a single neck’ should be designed to provide as much ergonomic mechanical leverage as possible for the musician and such an instrument should likewise be designed to provide as much ergonomic mechanical leverage as possible for the musician when he or she performs the more routine and less strenuous techniques of conventional fretting, stopping or barring of the strings. For a musician with a suitably large hand, a wider, up to a point, than ‘industry typical’ neck provides more ergonomic mechanical leverage for the musician's hand when conventionally bending the strings or performing a lateral vibrato and a thicker, up to a point, than ‘industry typical’ neck provides more ergonomic mechanical leverage for the musician's hand when performing conventional fretting, stopping or barring of the strings. Generally for a musician with a suitably large hand, a more open thumb, whether due to a neck that is wider than or thicker than an ‘industry typical’ neck, will consequently provide more ergonomic mechanical leverage than an ‘industry typical’ neck for all five of the above performance techniques, plus according to many audio engineers a larger neck mass, relative to the mass of the instrument's body, enables greater note sustain and induces a richer musical tone.

Since a thumb-side, supernumerarily-widened neck as described and claimed by this application can provide the hand with more ergonomic grip and pinch mechanical leverage than an ‘industry typical’ neck, such mechanical leverage equating to more comfort, string control and string bending range and therefore more musical expressiveness, it is unfortunate that during the advent of rock-n-roll creating significantly wider and also thicker guitar necks was not thoroughly explored then commercially developed. Today the ‘industry typical’ ‘neck width at the nut slot’ for a 6-string electric guitar is still as in the 1950's in the approximate range of 1.6500 to 1.7500 inches as evidenced by the high unit-volume 6-string electric guitar brands GIBSON, FENDER, PAUL REED SMITH and TAYLOR although TAYLOR, known mostly for its acoustic guitars, also has one option beyond 1.7500 inches which is a 1.8750 inches option for all of their 6-string electric guitar models and the ‘industry typical’ ‘neck width at the nut slot’ for a 6-string, steel string acoustic guitar of today is in the approximate range of 1.6875 to 1.8750 inches as evidenced by not only these same high unit-volume 6-string electric guitar brands of GIBSON, FENDER, PAUL REED SMITH and TAYLOR but also MARTIN. MARTIN, GIBSON, FENDER, PAUL REED SMITH and TAYLOR have collectively been innovative industry leaders throughout every decade since at least the 1940's with PAUL REED SMITH and TAYLOR being the most recent entrants.

Regarding the neck thicknesses, not widths, of today, the ‘neck thickness at the nut slot’ for an ‘industry typical’ ‘non-drone string, handheld stringed musical instrument with a single neck’ has never, pursuant to the Applicant's research and general stringed musical instrument awareness over the last forty years, been greater than 1.0000 inches and Cornell University's Ergonomics Web under DEA 3250/6510—Class Notes: Manual Materials Handling,
https://ergo.human.cornell.edu/DEA3250Flipbook/DEA3250notes/mmh.html#:˜:text=Allows%20us%20a%20great%20deal,%22%20or%20greater%20than%203%22
,last accessed on Feb. 16, 2024,
addresses the mechanical leverage shortcomings of any grippable object that is less than or equal to 1.0000 inches in thickness,
“Pinch grip strength decreases rapidly at spans less than 1″ or greater than 3″.”,
thus neck thicknesses of less than 1.0000 inches provide, for typical hand sizes, poor mechanical leverage which makes it harder to conventionally fret, stop and barre the strings as well as makes it harder to conventionally bend the strings and perform a lateral vibrato.

This Cornell University analysis corroborates well with an article titled, “Evaluation of Various Handle Grip Spans for Optimizing Finger Specific Force Based on the Users' Hand Sizes”, published by the journal Proceedings of the Human Factors and Ergonomics Society Annual Meeting on Oct. 1, 2007 in Volume 51, Issue 15, Pages 884-888,
https://www.researchgate.net/publication/267778409_Evaluation_of_Various_Handle_Grip_Spans_for_Optimizing_Finger_Specific_Force_Based_on_the_Users'_Hand_Sizes
,last accessed on Feb. 16, 2024,

which by evaluating hand grip strength for three specific hand sizes reveals in its abstract the mechanical leverage shortcomings of today's ‘industry typical’ ‘non-drone string, handheld stringed musical instruments with a single neck’ neck widths,

“This study evaluated the effects of handle grip span and user's hand size on maximum grip strength and individual finger force using a computerized digital dynamometer with five various grip spans (45, 50, 55, 60, and 65 mm). Forty-six males participated and were assigned into three hand size groups (small, middle, large) according to their hand lengths. Results showed that generally 55 and 50 mm grip spans had the highest grip strength (433.6N and 430.8N, respectively), whereas 65 mm grip span had the least grip strength. With respect to the interaction effect of grip span and hand size, small hand sized participants produced the highest grip forces at the 45 mm grip span, followed by 50 and 55 mm, middle hand size [d] participants provided the highest grip force at the 55 mm [grip span] followed by 50 and 45 mm, whereas large hand size [d] participants exerted the highest grip force at the 55 mm [grip span] followed by 60 mm.”, 45, 50, 55, 60, and 65 mm are respectively about 1.7717, 1.9685, 2.1654, 2.3622 and 2.5591 inches,
thus, depending upon a musician's particular hand size and his or her instrument, all ‘industry typical’ ‘non-drone string, handheld stringed musical instruments with a single neck’, not just 6-string electric guitars, whose ‘industry typical’ ‘neck width at the nut slot’ is typically in the range of 41 to 48 mm, but all others namely 6-string, steel string acoustic guitars, whose ‘industry typical’ ‘neck width at the nut slot’ is typically in the range of 42 to 48 mm, classical guitars, whose ‘industry typical’ ‘neck width at the nut slot’ is typically in the range of 50 to 55 mm, 4-string electric basses, whose ‘industry typical’ ‘neck width at the nut slot’ is typically in the range of 38 to 43 mm, ukuleles, whose ‘industry typical’ ‘neck width at the nut slot’ is typically in the range of 34 to 38 mm, mandolins, whose ‘industry typical’ ‘neck width at the nut slot’ is typically in the range of 28 to 32, violins, whose ‘industry typical’ ‘neck width at the nut slot’ is typically in the range of 23 to 26 mm and violas, whose ‘industry typical’ ‘neck width at the nut slot’ is typically in the range of 24 to 26 mm, can benefit from a thumb-side, supernumerarily-widened neck, as described and claimed by this application, since more neck width mechanical leverage allows the musician to conventionally bend the instrument's strings and perform a lateral vibrato with greater ease, comfort and control and similarly, though perhaps to a lesser extent, the musician can benefit from this increased neck width mechanical leverage when conventionally fretting, stopping or barring the strings.

Having been inundated over the years with the same ‘industry typical’ neck width choices, guitar players, for example, still covet the ‘industry typical’ neck width guitars of today, which are the same unreflective neck width carryovers and heralded “re-issues” that legendary guitar players such as Jimi Hendrix, Eric Clapton and Jimmy Page played on their famous records and tours decades ago, never seriously considering that a thumb-side, supermunerarily-widened neck can provide them with more mechanical leverage and therefore a means for more musical expressiveness. This same devotion to the past as reflected by the status quo of today also proves true for all other ‘industry typical’ ‘non-drone string, handheld stringed musical instruments with a single neck’ such as for Stradivarius violins. Furthermore regarding presumptions and expectations and therefore initial impressions, the prominently asymmetrical string set placement on a ‘non-drone string, handheld stringed musical instrument with a thumb-side, supernumerarily-widened neck’ challenges one's intuition since having one string set indentation, the ‘thumb-side continuous set of indentations’, significantly and noticeably wider than the other, the ‘finger-side continuous set of indentations’, at least ⅜ of an inch wide compared to typically either ⅛ of an inch or 3 mm wide, appears disorderly and non-harmonious suggesting a functional deficiency due to a lack of symmetry in a musical instrument whose string set placement has always been, or designed to be very nearly so, thumb-side/finger-side string set indentation symmetrical in relation to its ‘neck face’.

### BACKGROUND OF THE INVENTION—FIELD OF THE INVENTION

Any musician with a suitably large hand will ergonomically, i.e. mechanical leverage, benefit when playing an ‘industry typical’ ‘non-drone string, handheld stringed musical instrument with a single neck’ if that instrument's neck is replaced with a thumb-side, supernumerarily-widened neck as described and claimed by this application and also any musician with a suitably large hand will ergonomically, i.e. mechanical leverage, benefit when playing a ‘non-drone string, handheld stringed musical instrument with a single neck’ that is being, has been or will be originally built with a thumb-side, supernumerarily-widened neck as described and claimed by this application.

### BACKGROUND OF THE INVENTION—RELATED ART

Utility patent applications based upon ergonomically increased grip and pinch mechanical leverage are not new to the U.S. Patent and Trademark Office and such applications have been granted patents in a variety of fields such as for writing pens, dental tools and sporting accessories with U.S. Pat. No. 5,988,909 titled “Writing Instrument With Ergonomic Grip”, U.S. Pat. No. 6,471,514 titled “Ergonomic Grip For Hand Instruments” and U.S. Pat. No. 11,325,014 titled “Ergonomic Grip Sleeve For Sport Sticks” being a few representative examples.

### BRIEF SUMMARY OF THE INVENTION

A thumb-side, supernumerarily-widened neck, while still providing, by definition, for the same variety of ‘non-drone string, handheld stringed musical instrument with a single neck”s ‘industry typical’ ‘string set configurations’ and three-dimensional nut and nut slot profiles and, relative to the ‘finger-side longitudinal edge of the ‘neck face”, the same variety of ‘industry typical’ ‘string set placements’ and nut and nut slot placements as well as other ‘industry typical’ elements and features, further and definitively provides for a much more distant, i.e. a supernumerarily distant, string set placement and nut and nut slot placement relative to the ‘thumb-side longitudinal edge of the ‘neck face”. Specifically, a thumb-side, supernumerarily-widened neck, as described and claimed by this application, provides for at least ⅜ of an inch of neck width, a width that is measured upon the ‘neck width plane’, is parallel to the ‘neck width at the nut slot”s line segment and is at its maximum and full width on the ‘neck width plane’, to be blended into any longitudinal portion of the neck ‘below the nut slot’, such longitudinal portion is most often expected to span the entire length of the neck ‘below the nut slot’, that lies between the ‘thumb-side longitudinal edge of the ‘neck face” and the neck plane segment that begins on the ‘neck face’ then follows the anticipated perpendicular projection, perpendicular in relation to the ‘neck width plane’, of the segment of the last string in the string set that correlates to the above “any longitudinal portion of the neck ‘below the nut slot’”, with such projection then continuing its perpendicular path towards then through the ‘neck width plane’ with the remaining perimeter of the neck plane segment being defined by the points where the perpendicular plane projection exits the neck directly underneath the ‘neck face’ where the perimeter of the neck plane segment initially began, with such blending and requisite shape altering coordinated and occurring, per each thumb-side, supernumerarily-widened neck's specific, overall three-dimensional design, in tandem, if necessary, across all other regions of the entire neck such as the regions ‘above or at the nut slot’.

A thumb-side, supernumerarily-widened neck, as described and claimed by this application, will provide more ergonomic mechanical leverage for a musician with a suitably large hand and therefore will allow such a musician to conventionally bend the instrument's strings and perform a lateral vibrato with greater ease, comfort and control thus allowing for greater musical expressiveness and similarly, though perhaps to a lesser extent, such a musician with a suitably large hand will also benefit from this increased neck width mechanical leverage when conventionally fretting, stopping or barring the strings and especially so if the increased neck width is suitably paired with an increase to the neck's thickness, although any advantages resulting from an increase to the neck's thickness is outside of the scope of this application's claims.

### BRIEF DESCRIPTION OF THE SEVERAL VIEWS OF THE DRAWING

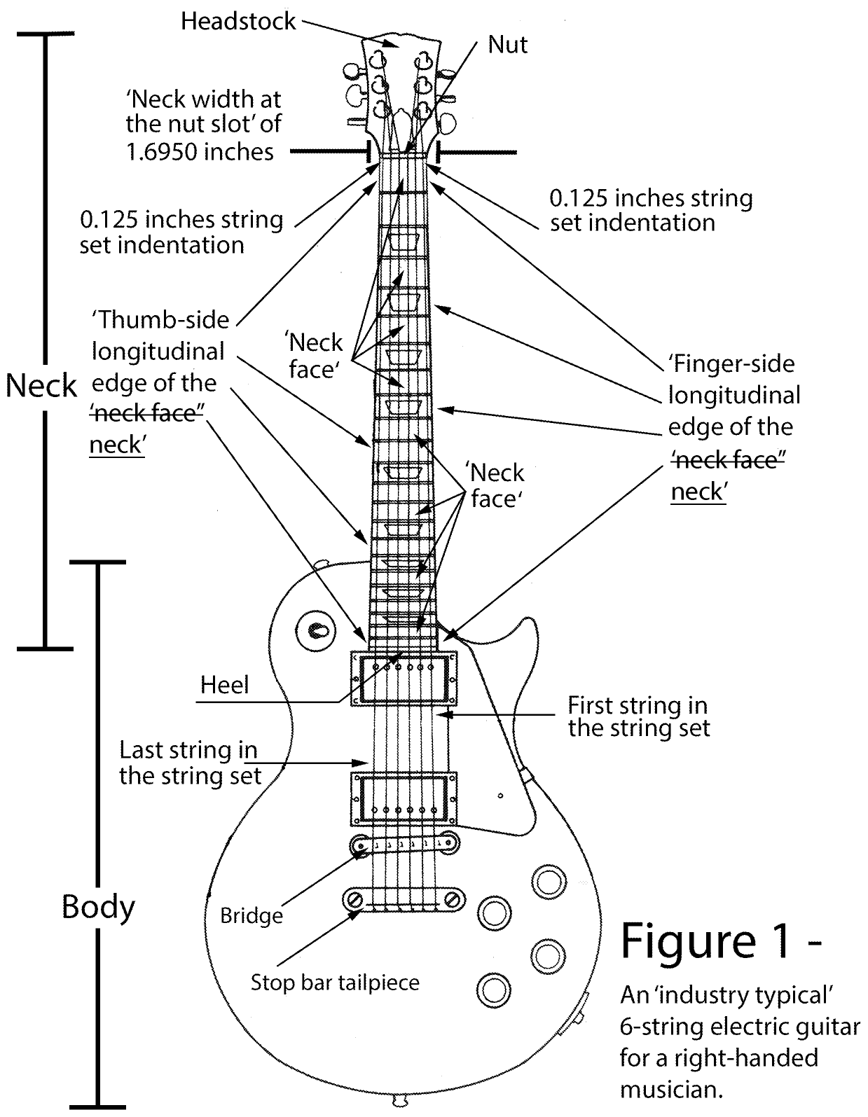

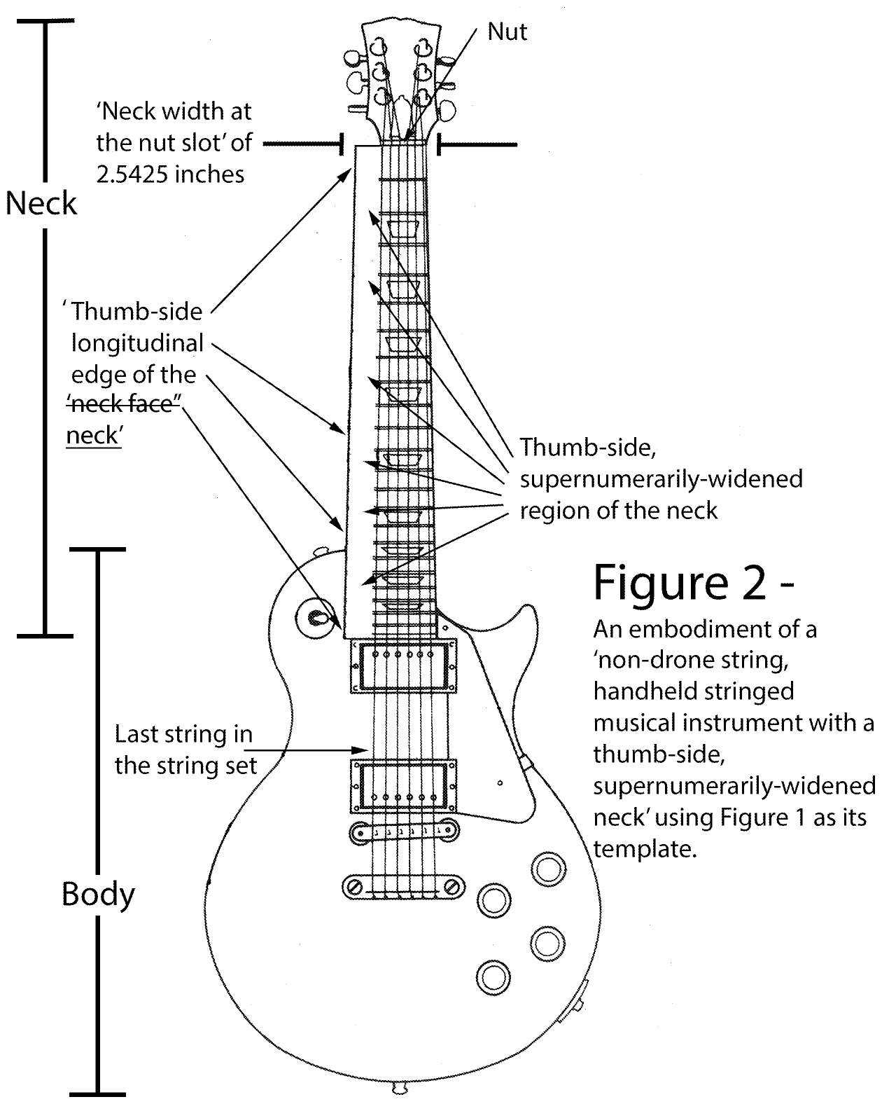

The two instrument drawings, FIG. 1 and FIG. 2, are only of top views because all bottom-view and side-view contours, elements and features for any template ‘industry typical’ neck's profile when compared to a correlating ‘non-drone string, handheld stringed musical instrument with a thumb-side, supernumerarily-widened neck’ neck's profile are irrelevant regarding, given a suitably large musician's hand, the comparative benefits of a thumb-side, supernumerarily-widened neck as described and claimed by this application. Specifically, FIG. 1 is a template ‘industry typical’ 6-string electric guitar, more specifically a GIBSON Les Paul styled guitar, for a right-handed musician with a ‘neck width at the nut slot’ of 1.6950 inches which is approximately 43.0530 mm whereas the FIG. 2 guitar, the guitar built by using FIG. 1 as its template, has the template's same ‘industry typical’ ‘string set configuration’, same ‘industry typical’ three-dimensional nut and nut slot profile and, relative to the ‘finger-side longitudinal edge of the ‘neck face”, the same ‘industry typical’ ‘string set placement’ and same ‘industry typical’ nut and nut slot placement as well as other ‘industry typical’ elements and features, but, despite modeling the ‘industry typical’ neck of the FIG. 1 guitar, the FIG. 2 guitar has a thumb-side, supernumerarily-widened neck, as described and claimed by this application, and consequently has a much wider ‘neck width at the nut slot’, a much wider ‘thumb-side string set indentation at the nut slot’ and a much wider ‘thumb-side continuous set of indentations’. Specifically the guitar in FIG. 2 has a ‘neck width at the nut slot’ that is 50% wider, i.e. 0.8475 inches or approximately 21.5265 mm wider, than the one in FIG. 1 which equates to a total ‘neck width at the nut slot’ of 2.5425 inches or approximately 64.5795 mm with this supernumerarily increased neck width then being linearly applied down the entire length of the neck between the ‘thumb-side longitudinal edge of the ‘neck face” and a perpendicular projection of the last string. FIG. 2 is an embodiment of a ‘non-drone string, handheld stringed musical instrument with a thumb-side, supernumerarily-widened neck’ as described and claimed by this application.

### DETAILED DESCRIPTION OF THE INVENTION

The word ‘supernumerary’ has “exceeding the usual, stated, or prescribed number”, as one of its definitions in the Merriam-Webster Dictionary,
https://www.merriam-webster.com/dictionary/supernumerary
last accessed on Feb. 16, 2024, so consequently constructing a ‘non-drone string, handheld stringed musical instrument with a thumb-side, supernumerarily-widened neck’ as described and claimed by this application requires no more skill or knowledge than when constructing an ‘industry typical’ ‘non-drone string, handheld stringed musical instrument with a single neck’ because the only difference in construction is that the ‘non-drone string, handheld stringed musical instrument with a thumb-side, supernumerarily-widened neck’ has a wider neck, a mere increase in magnitude that only requires a wider neck blank, not any fundamental design, shaping or tooling changes.

A ‘non-drone string, handheld stringed musical instrument with a thumb-side, supernumerarily-widened neck”s neck requires, as just stated, a wider than ‘industry typical’ neck blank and also perhaps a thicker and/or a longer than ‘industry typical’ neck blank depending upon if the neck design also provides for more vertical, i.e. a thicker neck, not just horizontal ergonomic mechanical leverage ‘below the nut slot’ and if the neck design provides for more neck length, not to alter the scale length, but rather, its sole purpose being to increase the neck's surface area which will ensure a stronger neck-to-body bond and therefore this increase in neck length is not considered to be a part of the ‘neck face’ and should be planed or shaped below the ‘neck face’ so as to not interfere with or tempt the musician's fretting, stopping or barring technique. However, even if the ‘non-drone string, handheld stringed musical instrument with a thumb-side, supernumerarily-widened neck”s neck design does require a longer and/or a thicker neck blank, any neck length increases or neck thickness increases are both outside of the claims of this application.

No more skill or knowledge is required to attach a ‘non-drone string, handheld stringed musical instrument with a thumb-side, supernumerarily-widened neck”s neck to the body of an existing ‘industry typical’ ‘non-drone string, handheld stringed musical instrument with a single neck’ matching instrument type or to the neck-pocket-compatible body of a brand new matching instrument type, but an existing ‘industry typical’ ‘non-drone string, handheld stringed musical instrument with a single neck’ matching-instrument-type body will require its neck pocket to be made wider and also perhaps deeper and/or longer to fit the additional width and possible additional thickness and possible additional length of the neck such increased neck pocket dimensions to compensate for the additional weight and larger shape of a ‘non-drone string, handheld stringed musical instrument with a thumb-side, supernumerarily-widened neck”s neck, although alternatively the thumb-side, supernumerarily-widened neck's heel can always be shaped and trimmed to fit an existing ‘industry typical’ ‘non-drone string, handheld stringed musical instrument with a single neck’ matching-instrument-type body's neck pocket, however, such a diminutive size might not provide adequate joint stability.

A ‘non-drone string, handheld stringed musical instrument with a thumb-side, supernumerarily-widened neck’ is played in the same manner as its ‘industry typical’ ‘non-drone string, handheld stringed musical instrument with a single neck’ counterpart, thus a musician with a suitably large hand can play a ‘non-drone string, handheld stringed musical instrument with a thumb-side, supernumerarily-widened neck’ without re-developing his or her lateral vibrato, conventional fretting, stopping, barring or string bending technique or any other technique, however, a thumb-side, supernumerarily-widened neck does require a period of time for the
vibrato/fretting/stopping/barring/string-bending/etc hand to acclimate itself to the new positional, tactile and leverage intuitions and interactions of its thumb and fingers since they are now more open relative to each other.

The first step in constructing a ‘non-drone string, handheld stringed musical instrument with a thumb-side, supernumerarily-widened neck”s neck is to determine the minimum dimensions of its neck blank which can be accomplished purely by design or by first selecting an ‘industry typical’ ‘non-drone string, handheld stringed musical instrument with a single neck’ as a template upon which ⅜ of an inch or more of neck width, the claimed supernumerary neck width increase that is always measured upon the ‘neck width plane’ and parallel to the ‘neck width at the nut slot”s line segment, is added to the template's ‘maximum neck width from the last string to the ‘finger-side longitudinal edge of the ‘neck face” to determine the minimum neck blank width whereas the minimum neck blank length is determined by the template's ‘overall neck length’ or a supernumerary increase to the template's ‘overall neck length’ to provide for, not a longer scale length, but a greater neck-to-body mounting surface area allowing for a stronger bond and the minimum neck blank thickness is determined by the template's ‘maximum neck thickness’ or a supernumerary increase to the template's ‘maximum neck thickness’ which could, depending upon the musician's hand size, further this application's goal of increased ergonomic mechanical leverage for the musician's hand ‘below the nut slot’. Finally, ¼ of an inch should be added to each neck blank minimum dimension to circumvent surface blemishes and to provide a material tolerance during the initial shaping.

With the neck blank dimensions determined, the ‘non-drone string, handheld stringed musical instrument with a thumb-side, supernumerarily-widened neck”s actual neck construction can begin.

As described and claimed by this application, a ‘non-drone string, handheld stringed musical instrument with a thumb-side, supernumerarily-widened neck”s neck is quite similar to an ‘industry typical’ ‘non-drone string, handheld stringed musical instrument with a single neck”s neck since by definition it provides for the same variety of ‘industry typical’ ‘string set configurations’, three-dimensional nut and nut slot profiles and relative to the ‘finger-side longitudinal edge of the ‘neck face” the same variety of ‘industry typical’ ‘string set placements’ and nut and nut slot placements as well as other ‘industry typical’ elements and features, but varies in having at least ⅜ of an inch of neck width, the claimed supernumerary neck width increase, between the ‘thumb-side longitudinal edge of the ‘neck face” and a perpendicular projection of the last string in the string set.

As the above “BRIEF DESCRIPTION OF THE SEVERAL VIEWS OF THE DRAWING” shows, one specific way a ‘non-drone string, handheld stringed musical instrument with a thumb-side, supernumerarily-widened neck”s neck can be constructed is by pragmatically modeling from a template, accordingly this application's required neck construction itemization, 37 CFR 1.71 (a), will proceed by continuing with both the template that was used to determine the above neck blank dimensions and with the thumb-side, supernumerarily-widened neck blank that those dimensions generated and therefrom incorporate into the new neck that specific template's ‘industry typical’ ‘string set configuration’, three-dimensional nut and nut slot profile and relative to the ‘finger-side longitudinal edge of the ‘neck face” incorporate the template's same ‘industry typical’ ‘string set placement’ and nut and nut slot placement at some time after you first, with the template as your model, blend into, any longitudinal portion of the neck ‘below the nut slot’, such longitudinal portion is most often expected to span the entire length of the neck ‘below the nut slot’, that lies between the ‘thumb-side longitudinal edge of the ‘neck face” and the neck plane segment that begins on the ‘neck face’ then follows the anticipated perpendicular projection, perpendicular in relation to the ‘neck width plane’, of the segment of the last string in the string set that correlates to the above “any longitudinal portion of the neck ‘below the nut slot’ “, with such projection then continuing its perpendicular path towards then through the ‘neck width plane’ with the remaining perimeter of the neck plane segment being defined by the points where the perpendicular plane projection exits the neck directly underneath the ‘neck face’ where the perimeter of the neck plane segment initially began,
at least ⅜ of an inch of neck width, the claimed supernumerary neck width increase that is always measured upon the ‘neck width plane’, is parallel to the ‘neck width at the nut slot” s line segment and is at its maximum and full width on the ‘neck width plane’,
with such blending and requisite shape altering coordinated and occurring, per the thumb-side, supernumerarily-widened neck's specific, template-based, overall three-dimensional design, in tandem, if necessary, across all other regions of the entire neck such as the regions ‘above or at the nut slot’,
then, a truss rod, if present in the template, may be incorporated, however, due to the increased girth and therefore increased rigidity of the thumb-side, supernumerarily-widened neck being constructed, such truss rod incorporation may not be necessary and then after resolving all truss rod necessities, a glued-on fingerboard or fretboard which may be a scalloped fretboard, if present in the template, will be glued on and then blended in with the rest of the neck quite likely by hand using microgrit sandpaper.

Also at convenient times throughout the neck's construction, each non-neck profile element and feature that is present in the template, such as threaded inserts at the heel or any inlay or side dots, can be incorporated into the thumb-side, supernumerarily-widened neck under construction.

Finally, as evident from the above template-based construction, a thumb-side, supernumerarily-widened neck, as described and claimed by this application, can likewise be constructed by proceeding with a purely conceptual, non-template-based design.

What is claimed is:

1. A neck for a ‘non-drone string, handheld stringed musical instrument with a single neck’ comprising a neck construction that provides for a thumb-side-, supernumerarily-widened neck having at least ⅜ of an inch of total, not additionally wide, neck width inches, as measured upon the ‘neck width plane’, parallel to the ‘neck width at the nut slot”s line segment and at its maximum and full width on the ‘neck width plane’, per the neck's overall three-dimensional design, blended into the design-specified longitudinal portion of the neck ‘below the nut slot’, such longitudinal portion is most often expected to span the entire length of the neck ‘below the nut slot’, that lies between the ‘thumb-side longitudinal edge of the ‘neck’ and the neck plane segment that begins on the ‘neck face’ then follows the anticipated perpendicular projection, perpendicular in relation to the ‘neck width plane’, of the segment of the last string in the string set that correlates to the above “design-specified longitudinal portion of the neck ‘below the nut slot’”, with such projection then continuing its perpendicular path towards then through the ‘neck width plane’ with the remaining perimeter of the neck plane segment being defined by the points where the perpendicular plane projection exits the neck directly underneath the ‘neck face’ where the perimeter of the neck plane segment initially began, with such blending and requisite shape altering being coordinated and occurring, per the thumb-side, supernumerarily-widened neck's specific, overall three-dimensional design, in tandem, if necessary, across all other regions of the entire neck such as the regions ‘above or at the nut slot’.
